(19) United States
(12) Patent Application Publication
(10) Pub. No.: US 2023/0156652 A1
(43) Pub. Date: May 18, 2023

(54) 5G-GUTI DELETION TIME CONSIDERING REGISTRATION STATUS OVER ACCESSES

(71) Applicant: MEDIATEK INC., Hsin-Chu (TW)

(72) Inventors: YUAN-CHIEH Lin, Hsin-Chu (TW); Yu-Hsin Lin, Hsin-Chu (TW)

(21) Appl. No.: 17/966,732

(22) Filed: Oct. 14, 2022

Related U.S. Application Data
(60) Provisional application No. 63/278,507, filed on Nov. 12, 2021.

(51) Int. Cl. H04W 60/00; H04W 60/06

(52) U.S. Cl. CPC H04W 60/005; H04W 60/06; H04W 84/042

(57) ABSTRACT

When a UE is registered to the same PLMN or SNPN over 3GPP and non-3GPP access, the UE and the AMF maintain one 5G-GUTI that is common to both 3GPP and non-3GPP access. When the UE is required to re-register to the network, the UE follows the procedures of deregister over both accesses, delete the common shared 5G-GUTI, and re-register over both accesses. The UE needs to perform the above procedures in a graceful sequence. In one novel aspect, the UE triggers the re-registration (either over 3GPP or non-3GPP access) after the completion of deregistration over both 3GPP and non-3GPP access. In addition, the UE deletes the common 5G-GUTI only after the completion of deregistration over both 3GPP and non-3GPP access.

### CROSS REFERENCE TO RELATED APPLICATION

This application claims priority under 35 U.S.C. §119 from U.S. Provisional Application No. 63/278,507 entitled “5G-GUTI deletion time considering registration status over accesses,” filed on Nov. 12, 2021, the subject matter of which is incorporated herein by reference.

### TECHNICAL FIELD

The disclosed embodiments relate generally to wireless communication systems, and, more particularly, to handling 5G-GUTI deletion time for UE deregistration and registration to the same PLMN or SNPN over both 3GPP and non-3GPP accesses.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (e.g., eNodeBs or eNBs) communicating with a plurality of mobile stations, referred to as user equipments (UEs). The 3^{rd} generation partner project (3GPP) network normally includes a hybrid of 2G/3G/4G systems. The Next Generation Mobile Network (NGMN) board has decided to focus the future NGMN activities on defining the end-to-end requirements for 5G new radio (NR) systems. The base stations in 5G NR systems are referred to as Next Generation Node-Bs (e.g., gNodeBs or gNBs).

Non-access stratum (NAS) is used to convey non-access-stratum signaling between UE and the Mobility Management Entity (MME) or the Access and Mobility Management Function (AMF) for an LTE/NR access. A NAS signaling connection can be established via an Attach procedure in 4G/LTE or via a registration procedure in 5G/NR, involving UE subscription and identity. A temporary user identity for 5GS-based services, the 5G globally unique temporary identity (5G-GUTI), is used for identification of a registered UE. When the UE is registered to different PLMNs or SNPNs over 3GPP access and non-3GPP access, the UE maintains two 5G-GUTIs, a 5G-GUTI for the registration with a PLMN or SNPN over the 3GPP access and another 5G-GUTI for the registration with another PLMN or SNPN over the non-3GPP access. When the UE is registered to the same PLMN or SNPN over 3GPP and non-3GPP access, the UE and the AMF maintain one 5G-GUTI that is common to both 3GPP and non-3GPP access.

When the UE is required to delete the 5G-GUTI according to a NAS procedure, the UE shall delete the 5G-GUTI only if the UE can be sure that this 5G-GUTI is no longer used in any later procedure. When the UE is required to re-register to the network, the UE follows the procedures of deregister over both accesses, delete the common shared 5G-GUTI, and re-register over both accesses. The UE needs to perform the above procedures in a graceful sequence to ensure that 1) the UE won’t have no available 5G-GUTI to use, and 2) the UE won’t use multiple 5G-GUTIs for the same network in different procedures.

A solution is sought.

### SUMMARY

A method for handling 5G-GUTI deletion time for UE deregistration and registration to the same PLMN or SNPN over both 3GPP and non-3GPP accesses is provided. When a UE is registered to the same PLMN or SNPN over 3GPP and non-3GPP access, the UE and the AMF maintain one 5G-GUTI that is common to both 3GPP and non-3GPP access. When the UE is required to re-register to the network, the UE follows the procedures of deregister over both accesses, delete the common shared 5G-GUTI, and re-register over both accesses. The UE needs to perform the above procedures in a graceful sequence. In one novel aspect, the UE triggers the re-registration (either over 3GPP or non-3GPP access) after the completion of deregistration over both 3GPP and non-3GPP access. In addition, the UE deletes the common 5G-GUTI only after the completion of deregistration over both 3GPP and non-3GPP access.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a user equipment (UE) and a 5G network handling 5G-GUTI deletion, de-registration, and re-registration to the same Public Land Mobile Network or Standalone non-public Network (PLMN/SNPN) over both 3GPP and non-3GPP access types in accordance with one novel aspect.

FIG. 2 is a simplified block diagram of a UE and a network entity in accordance with various embodiments of the present invention.

FIG. 3 illustrates one example of the timing on UE performing deregistration over different access types and the deletion of a shared 5G-GUTI.

FIG. 4 illustrates one embodiment of a graceful sequence for performing 5G-GUTI deletion, UE registration and deregistration over both 3GPP and non-3GPP accesses in accordance with one novel aspect.

FIG. 5 illustrates a sequence flow between a UE and a 5GS for performing re-registration to the same PLMN/SNPN over both 3GPP and non-3GPP access types in accordance with one novel aspect.

FIG. 6 is a flow chart of a first method of performing re-registration to the same PLMN/SNPN over both 3GPP and non-3GPP access types in accordance with one novel aspect of the current invention.

FIG. 7 is a flow chart of a second method of performing re-registration to the same PLMN/SNPN over both 3GPP and non-3GPP access types in accordance with one novel aspect of the current invention.

### DETAILED DESCRIPTION

Reference will now be made in detail to some embodiments of the invention, examples of which are illustrated in the accompanying drawings.

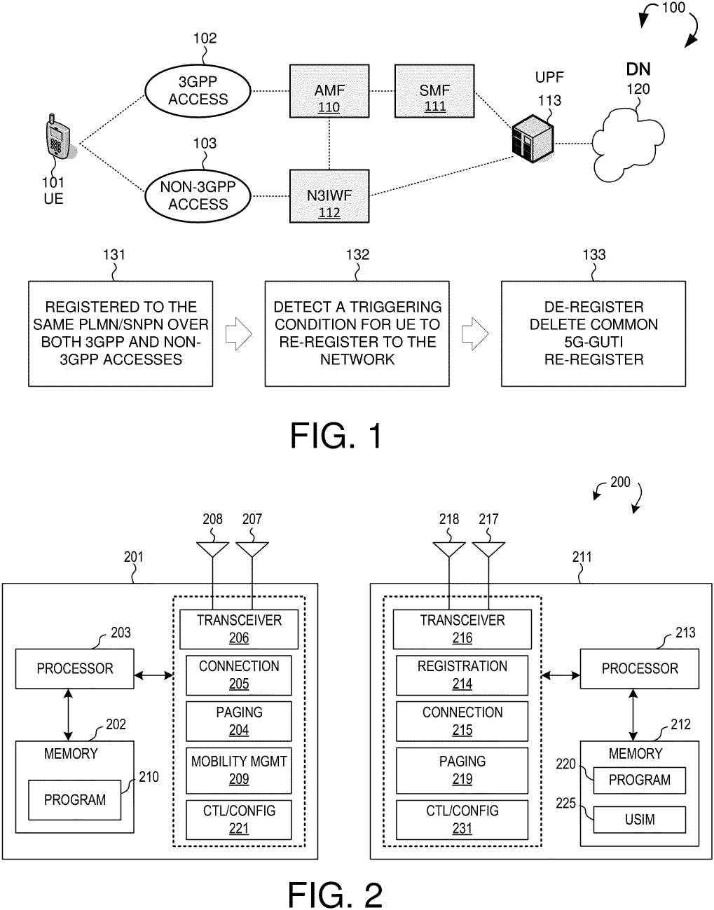

FIG. 1 illustrates a user equipment (UE) and a 5G network 100 handling 5G-GUTI deletion, de-registration, and re-registration to the same Public Land Mobile Network or Standalone non-public Network (PLMN/SNPN) over both 3GPP and non-3GPP access types in accordance with one novel aspect. In 3GPP network, a plurality of base stations, e.g., Next Generation Node-Bs (gNodeBs or gNBs) communicating with a plurality of mobile stations referred as user equipment (UEs). 5G new radio (NR) network 100 includes a UE 101, a 3GPP access 102 (e.g., a 3GPP radio access network (RAN)), a non-3GPP access 103 (e.g., a non-3GPP RAN), an access and mobility management function (AMF) 110, a session management function (SMF) 111, a non-3GPP interworking function (N3IWF) 112, a user plane function (UPF) 113, and a data network 120. The AMF 110 communicates with the base stations in the 3GPP access 102, the SMF 111, and the UPF 113 for access and mobility management of wireless access devices in the 5G network 100. The SMF 111 is primarily responsible for interacting with the decoupled data plane, creating, updating, and removing PDU sessions and managing session context with the UPF 113. The N3IWF 112 interfaces to 5G core network control plane functions.

In Access Stratum (AS) layer, an RAN provides radio access for the UE 101 via a radio access technology (RAT). In Non-Access Stratum (NAS) layer, the AMF 110 and the SMF 111 communicate with RAN and 5GC for access and mobility management and PDU session management of wireless access devices in the 5G network 100. The 3GPP access 102 may include base stations (gNBs or eNBs) providing radio access for the UE 101 via various 3GPP RATs including NR, EUTRA, or 3G/2G. The non-3GPP access 103 may include access points (APs) providing radio access for the UE 101 via non-3GPP RAT including WiFi. The UE 101 can obtain access to data network 120 through 3GPP access 102, AMF 110, SMF 111, and UPF 113. The UE 101 can obtain access to data network 120 through non-3GPP access 103, N3IWF 112, AMF 110, SMF 111, and UPF 113. The UE 101 may be equipped with a single radio frequency (RF) module or transceiver or multiple RF modules or transceivers for services via different RATs/CNs. In some examples, UE 101 may be a smart phone, a wearable device, an Internet of Things (IoT) device, a tablet, etc.

The NAS layer is used to convey non-radio (non-access-stratum) signaling between UE and the AMF for NR access or non-3GPP access. A NAS signaling connection can be established via a registration procedure in 5G/NR, involving UE subscription and identity. A temporary user identity for 5GS-based services, the 5G-GUTI, is used for identification of a registered UE. When the UE is registered to different PLMNs or SNPNs over 3GPP access and non-3GPP access, the UE maintains two 5G-GUTIs, a 5G-GUTI for the registration with a PLMN or SNPN over the 3GPP access and another 5G-GUTI for the registration with another PLMN or SNPN over the non-3GPP access. When the UE is registered to the same PLMN or SNPN over 3GPP and non-3GPP access, the UE and the AMF maintain one 5G-GUTI that is common to both 3GPP and non-3GPP access. When the UE is required to delete the 5G-GUTI according to a NAS procedure, the UE shall delete the 5G-GUTI only if the UE can be sure that this deleted 5G-GUTI is no longer used in any later procedure.

In the example of FIG. 1, UE 101 is registered to the same PLMN/SNPN over 3GPP and non-3GPP access (step 131). UE then detects a triggering condition to re-register to the network (step 132). For example, UE 101 receives a DL NAS TRANSPORT message with Payload container type IE is set to “UE parameters update transparent container” and the Payload container IE successfully passes the integrity check. UE parameters update list includes a UE-parameters update data set with UE-parameters update data set type indicating “Routing indicator update data”, UE receives a REFRESH command from the UICC, and the REG bit of the UE parameters update header in the UE parameters update transparent container IE is set to “re-registration requested”. At the moment, UE registered to both 3GPP and non-3GPP access at the same PLMN, now the UE needs to deregister from 5GS, delete the common 5G-GUTI, and registers back to 5GS.

Note that UE 101 has a 5G-GUTI that is common to the same PLMN or SNPN (because UE registered to same PLMN or SNPN over 3GPP and non-3GPP access). When the UE is required to re-register to the network, the UE follows the procedures of deregister over both accesses, delete the common shared 5G-GUTI, and re-register over both accesses (step 133). The UE needs to perform the above procedures in a graceful sequence to ensure that 1) the UE won’t have no available 5G-GUTI to use in any procedure that requires the usage of the original 5G-GUTI, and 2) the UE won’t use multiple 5G-GUTIs for the same network in different procedures. In one novel aspect, UE 101 triggers the re-registration (either over 3GPP or non-3GPP access) after the completion of deregistration over both 3GPP and non-3GPP access. In addition, UE 101 deletes the common 5G-GUTI only after the completion of deregistration over both 3GPP and non-3GPP access.

FIG. 2 is a simplified block diagram of wireless devices 201 and 211 in accordance with embodiments of the present invention. For wireless device 201 (e.g., a network entity AMF), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a user equipment), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in UE 211. Memory 212 stores program instructions and data 220 and USIM card 225 to control the operations of UE 211.

The wireless devices 201 and 211 also include several functional modules and circuits that can be implemented and configured to perform embodiments of the present invention. In the example of FIG. 2, wireless device 201 is an AMF that includes a NAS singling connection handling module 205, a paging module 204, a mobility management module 209, and a control and configuration circuit 221. Wireless device 211 is a UE that includes a connection handling module 215, a registration module 214 (for Registration handling), a paging and mobility handling module 219, and a control and configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow AMF 201 and UE 211 to perform embodiments of the present invention.

In one example, UE 211 performs registration and deregistration with the network via registration module 214, establishes signaling connection via connection handling circuit 215, monitors paging via paging module 219, and obtains configuration information via control and configuration circuit 231. In one example, when the UE is required to re-register to the same network, the UE follows the procedures of deregister over both accesses, delete the common shared 5G-GUTI, and re-register over both accesses. In one novel aspect, the UE triggers the re-registration (either over 3GPP or non-3GPP access) after the completion of deregistration over both 3GPP and non-3GPP access. In addition, the UE deletes the common 5G-GUTI only after the completion of deregistration over both 3GPP and non-3GPP access.

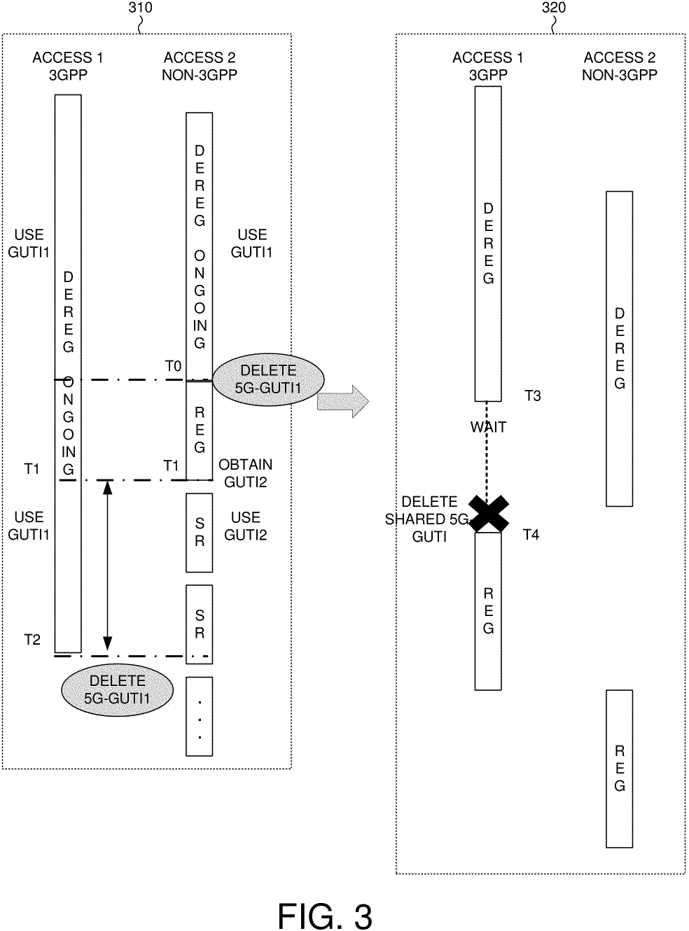

FIG. 3 illustrates one example of the timing on UE performing deregistration over different access types and the deletion of a shared 5G-GUTI. Under certain scenario of FIG. 3, a UE is registered to the same PLMN or SNPN over both 3GPP (e.g., access 1) and non-3GPP (e.g., access 2), and the UE has a shared 5G-GUTI (e.g., 5G-GUTI1) common to the same PLMN or SNPN. The UE is then required to perform re-registration to the network. For example, the UE receives a DL NAS TRANSPORT message with Payload container type IE is set to “UE parameters update transparent container” and the Payload container IE successfully passes the integrity check. UE parameters update list includes a UE-parameters update data set with UE-parameters update data set type indicating “Routing indicator update data”, UE receives a REFRESH command from the UICC, and the REG bit of the UE parameters update header in the UE parameters update transparent container IE is set to “re-registration requested”.

The UE needs to perform the following procedures: (1) UE deregisters from/over 3GPP access (2) UE deregisters from/over non-3GPP access (3) UE deletes 5G-GUTI (4) UE registers over 3GPP access (5) UE registers over non-3GPP access. If the above procedures are not performed in certain sequence, then such handling may have problems. In a first example, if the deletion of 5G-GUTI is executed when the first de-registration is finished/started but the second de-registration is not finished/started, this will cause there is no available 5G-GUTI can be used in the second de-registration. In a second example, if one of the de-registrations takes a long time, e.g., when guard timer for deregistration request is timeout under abnormal case. This will cause the same UE uses different 5G-GUTI in the same network during different procedures, which will then result in the requirement for the network to support multiple UE contexts.

As depicted in 310 of FIG. 3, UE uses a first 5G-GUTI1 after registration over both 3GPP (e.g., access 1) and non-3GPP accesses(e.g., access 2). The deregistration over non-3GPP access is completed before the deregistration over 3GPP access. In a first example, if the UE deletes the 5G-GUTI1 at time T0 after deregistration from non-3GPP access is completed, then the UE has no available 5G-GUTI in the deregistration procedure over 3GPP access. In a second example, if the UE does not delete 5G-GUTI at time T0 and obtains a second 5G-GUTI2 at time T1 after registering over non-3GPP access, and the UE continues to use 5G-GUTI1 before de-registration over 3GPP access is completed at time T2, it will result in the UE uses 5G-GUTI1 and 5G-GUTI2 from T1 to T2 in the same network during different procedures.

In one novel aspect, the above procedures are performed by the UE in a graceful sequence. If the UE is registered over 3GPP access, then the UE shall wait until the emergency services over 3GPP access, if any, are completed, enter IDLE or INACTIVE mode, perform deregistration procedure, and then wait until the deregistration procedure over non-3GPP is completed before deleting its 5G-GUTI if the UE is registered to the same PLMN or SNPN on non-3GPP access, and then initiate a registration procedure for initial registration. As depicted in 320 of FIG. 3, the UE completes deregistration from 3GPP access at time T3. Since the UE has not completed de-registration from non-3GPP access, the UE waits until time T4 and then deletes the shared 5G-GUTI. After deleting the shared 5G-GUTI, the UE can start performing re-registration procedure over either 3GPP or non-3GPP access, i.e., the UE can re-register to 3GPP access only after the de-registration over non-3GPP access is completed.

Similarly, if the UE is registered over non-3GPP access, then the UE shall wait until the emergency services are completed, enter IDLE mode over non-3GPP access, perform de-registration procedure, and then wait until the de-registration procedure over 3GPP access is completed before deleting its 5G-GUTI if the UE is registered to the same PLMN or SNPN on 3GPP access, and then initiate a registration procedure for initial registration over non-3GPP access, i.e., the UE can re-register to non-3GPP access only after the de-registration over 3GPP access is completed.

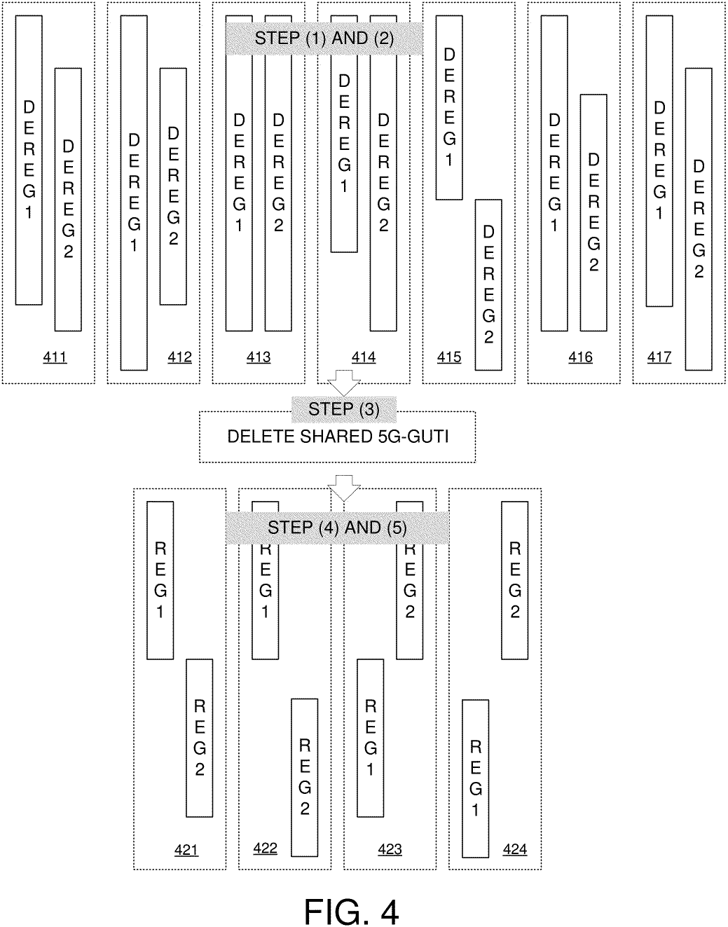

FIG. 4 illustrates one embodiment of a graceful sequence for performing 5G-GUTI deletion, UE registration and deregistration over both 3GPP and non-3GPP accesses in accordance with one novel aspect. After a UE registered to the same PLMN/SNPN over both 3GPP and non-3GPP access and sharing a common 5G-GUTI, the UE may be required to re-register to two accesses of the network under certain scenario. The UE then needs to perform the following procedures: (1) UE deregisters from/over 3GPP access (2) UE deregisters from/over non-3GPP access (3) UE deletes a common 5G-GUTI (4) UE registers over 3GPP access (5) UE registers over non-3GPP access. In accordance with one novel aspect, the UE can only perform step (3) after the completion of both steps (1) and step (2), e.g., the deletion of the common 5G-GUTI can only happen after the UE has completed de-registration from both 3GPP and non-3GPP accesses. Furthermore, the UE can only perform step (4) or step (5) after steps (1) and step (2) are both completed, e.g., the UE can preform re-registration over either 3GPP or non-3GPP access, or both, only after the UE has completed de-registration from both 3GPP and non-3GPP accesses. In other words, UE can perform re-registration over either 3GPP or non-3GPP access only after the common 5G-GUTI is deleted in step (3) after performing steps (1) and (2).

FIG. 4 has depicted some possible scenarios of the above procedures (1) to (5) in a graceful sequence as described. DEREG1 represents deregistration over 3GPP access, DEREG2 represents deregistration over non-3GPP access, REG1 represents registration over 3GPP access, and REG2 represents registration over non-3GPP access. Some different scenarios of the de-registration procedures (steps (1) and (2)) are depicted by 411-417. In 411, UE starts DEREG1 first and completes DEREG1 before DEREG2,. In 412, UE starts DEREG1 first and completes DEREG1 after DEREG2, where DEREG1 is longer than DEREG2. In 413, UE starts and completes DEREG1 and DEREG2 at the same time, where DEREG1 is the same as DEREG2. In 414, UE starts DEREG1 and DEREG2 at the same time, and completes DEREG1 is before DEREG2. In 415, UE starts DEREG2 until after DEREG1 is completed. In 416, UE starts DEREG1 first and completes DEREG1 and DEREG2 at the same time. In 417, UE starts DEREG1 first and completes DEREG1 before DEREG2, where DEREG1 is the same as DEREG2. Note that the order of DEREG1 and DEREG2 is interchangeable. The different scenarios of the registration procedures (steps (4) and (5)) are depicted by 421-424, which are performed after or at the same time as step (3). In 421, UE performs REG1 first and performs REG2 upon the completion of REG1. In 422, UE performs REG1 first and performs REG2 sometime after the completion of REG1. In 423, UE performs REG2 first and performs REG1 upon the completion of REG2. In 424, UE performs REG2 first and performs REG1 sometime after the completion of REG2.

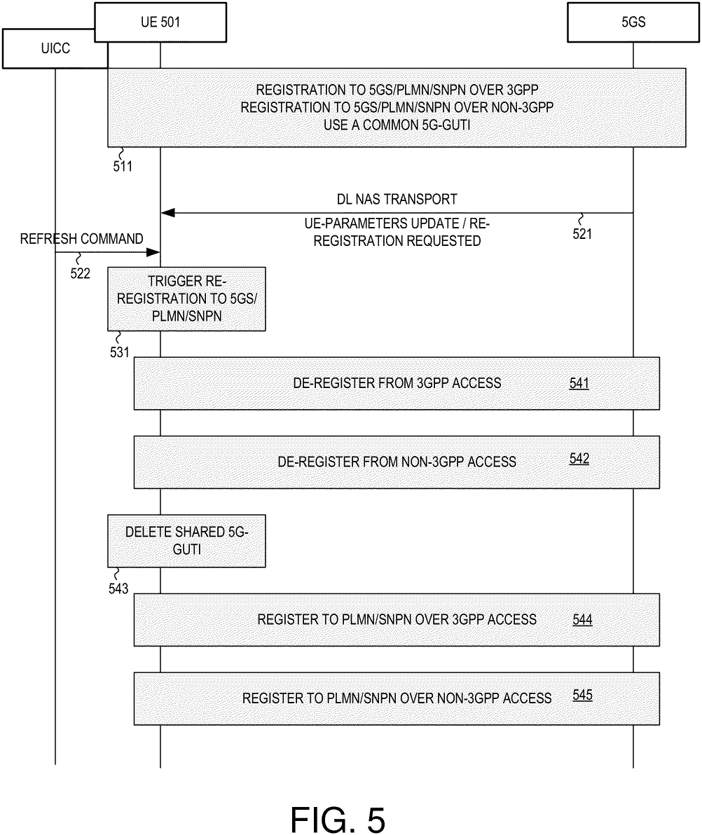

FIG. 5 illustrates a sequence flow between a UE and a 5GS for performing re-registration to the same PLMN/SNPN over both 3GPP and non-3GPP access types in accordance with one novel aspect. In step 511, UE 501 registers to the same PLMN/SNPN in 5GS over both 3GPP access and non-3GPP access. UE 501 uses/maintains a common 5G-GUTI in the same network. In step 521, UE 501 receives a DL NAS TRANSPORT message with Payload container type IE is set to “UE parameters update transparent container” and the Payload container IE successfully passes the integrity check. In step 522, UE 501 receives a REFRESH command from the UICC, and the REG bit of the UE parameters update header in the UE parameters update transparent container IE is set to “re-registration requested”. Accordingly, in step 531, UE 501 determines that the UE is required to re-register to the network. In step 541, UE 501 performs deregistration from 3GPP access. In step 542, UE 501 performs deregistration from non-3GPP access. In step 543, UE 501 deletes the shared 5G-GUTI after both deregistration procedures are completed. In step 544, UE 501 performs registration to the PLMN/SNPN over 3GPP access. In step 545, UE 501 performs registration to the same PLMN/SNPN over non-3GPP access.

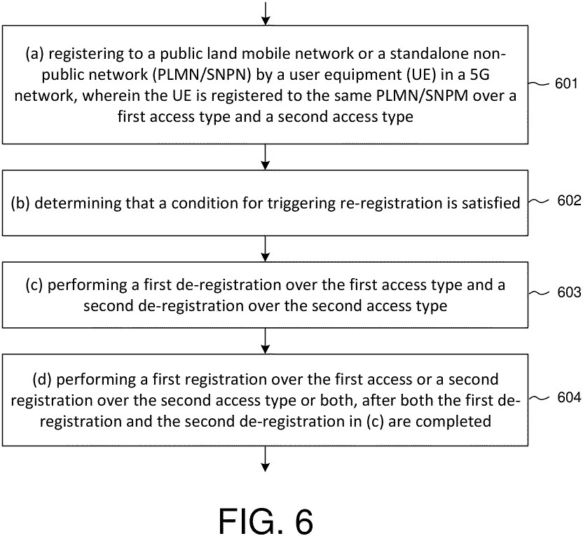

FIG. 6 is a flow chart of a first method of performing re-registration to the same PLMN/SNPN over both 3GPP and non-3GPP access types in accordance with one novel aspect of the current invention. In step 601, a UE registers to a public land mobile network or a standalone non-public network (PLMN/SNPN) in a 5G network, wherein the UE is registered to the same PLMN/SNPM over a first access type and a second access type. In step 602, the UE determines that a condition for triggering re-registration is satisfied. In step 603, the UE performs a first deregistration over the first access type and a second deregistration over the second access type. In step 604, the UE performs a first registration over the first access or a second registration over the second access type or both, after both the first de-registration and the second deregistration are completed.

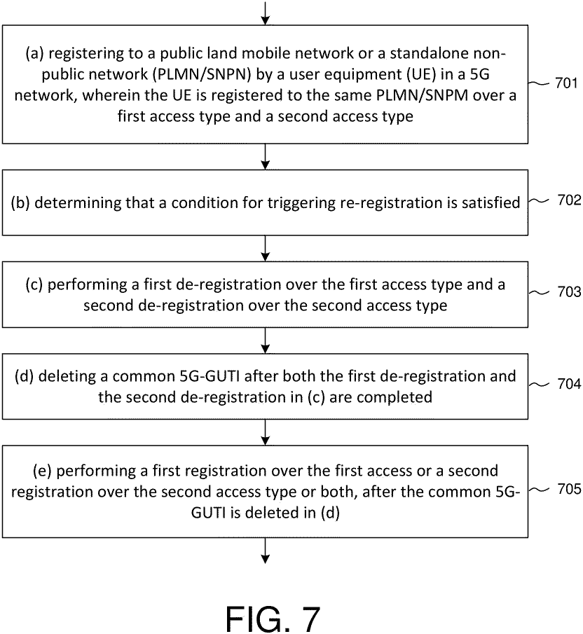

FIG. 7 is a flow chart of a second method of performing re-registration to the same PLMN/SNPN over both 3GPP and non-3GPP access types in accordance with one novel aspect of the current invention. In step 701, a UE registers to a public land mobile network or a standalone non-public network (PLMN/SNPN) in a 5G network, wherein the UE is registered to the same PLMN/SNPM over a first access type and a second access type. In step 702, the UE determines that a condition for triggering re-registration is satisfied. In step 703, the UE performs a first deregistration over the first access type and a second deregistration over the second access type. In step 704, the UE deletes a common 5G-GUTI after both the first deregistration and the second de-registration are completed. In step 705, the UE performs a first registration over the first access or a second registration over the second access type or both, after the common 5G-GUTI is deleted.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
(a) registering to a public land mobile network or a standalone non-public network (PLMN/SNPN) by a user equipment (UE) in a 5G network, wherein the UE is registered to the same PLMN/SNPM over a first access type and a second access type;
(b) determining that a condition for triggering re-registration is satisfied;
(c) performing a first de-registration over the first access type and a second de-registration over the second access type; and
(d) performing a first registration over the first access or a second registration over the second access type or both, after both the first de-registration and the second de-registration in (c) are completed.

2. The method of claim 1, wherein the UE receives a downlink NAS TRANSPORT message comprising a UE-parameters-update header.

3. The method of claim 2, wherein the triggering condition is satisfied when the UE receives a REFRESH COMMAND, and the UE-parameters-update header indicates re-registration requested.

4. The method of claim 1, wherein the first access type is 3GPP access and the second access type is non-3GPP access, or wherein the first access type is non-3GPP access and the second access type is 3GPP access.

5. The method of claim 1, wherein the UE maintains a first common 5G globally unique temporary identity (5G-GUTI) after the registration to the PLMN/SNPN in (a).

6. The method of claim 5, wherein the UE deletes the first common 5G-GUTI after both the first de-registration and the second de-registration in (c) are completed.

7. The method of claim 5, wherein the UE performs the first registration or the second registration or both, in (d) after the UE deletes the first common 5G-GUTI.

8. A User Equipment (UE), comprising:
a registration handling circuit that registers to a public land mobile network or a standalone non-public network (PLMN/SNPN) in a 5G network, wherein the UE is registered to the same PLMN/SNPM over a first access type and a second access type;
a control circuit that determines that a condition for triggering re-registration is satisfied; and
a de-registration handling circuit that performs a first de-registration over the first access type and a second de-registration over the second access type, wherein the UE performs a first registration over the first access or a second registration over the second access type or both, after both the first de-registration and the second de-registration are completed.

9. The UE of claim 8, wherein the UE receives a downlink NAS TRANSPORT message comprising a UE-parameters-update header.

10. The UE of claim 9, wherein the triggering condition is satisfied when the UE receives a REFRESH COMMAND, and the UE-parameters-update header indicates re-registration requested.

11. The UE of claim 8, wherein the first access type is 3GPP access and the second access type is non-3GPP access, or wherein the first access type is non-3GPP access and the second access type is 3GPP access.

12. The UE of claim 8, wherein the UE maintains a common 5G globally unique temporary identity (5G-GUTI) after the registration to the PLMN/SNPN in (a).

13. The UE of claim 12, wherein the UE deletes the common 5G-GUTI after both the first de-registration and the second de-registration in (c) are completed.

14. The UE of claim 12, wherein the UE performs the first registration or the second registration or both, in (d) after the UE deletes the common 5G-GUTI.

15. A method comprising:
(a) registering to a public land mobile network or a standalone non-public network (PLMN/SNPN) by a user equipment (UE) in a 5G network, wherein the UE is registered to the same PLMN/SNPM over a first access type and a second access type;
(b) determining that a condition for triggering re-registration is satisfied;
(c) performing a first de-registration over the first access type and a second de-registration over the second access type;
(d) deleting a common 5G-GUTI after both the first de-registration and the second de-registration in (c) are completed; and
(e) performing a first registration over the first access or a second registration over the second access type or both, after the common 5G-GUTI is deleted in (d).

16. The method of claim 15, wherein the UE receives a downlink NAS TRANSPORT message comprising a UE-parameters-update header.

17. The method of claim 16, wherein the triggering condition is satisfied when the UE receives a REFRESH COMMAND, and the UE-parameters-update header indicates re-registration requested.

18. The method of claim 15, wherein the first access type is 3GPP access and the second access type is non-3GPP access, or wherein the first access type is non-3GPP access and the second access type is 3GPP access.
